(19) United States
(12) Patent Application Publication
(10) Pub. No.: US 2010/0250988 A1
(43) Pub. Date: Sep. 30, 2010

(54) VIDEO DISPLAY SYSTEM, DISPLAY DEVICE, PLUG-IN MODULE AND POWER CONTROL METHOD OF PLUG-IN MODULE

(75) Inventors: Sachiko Okuda, Osaka (JP); Susumu Miyajima, Osaka (JP); Toyokazu Yanagimichi, Osaka (JP); Hidekazu Suzuki, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/740,032

(22) PCT Filed: Dec. 27, 2007
(86) PCT No.: PCT/JP2007/075094

§ 371 Date: Apr. 27, 2010

(51) Int. Cl. G06F 1/26; G06F 21/00

(52) U.S. Cl. 713/323; 726/21

(57) ABSTRACT

It provides a video display system capable of effective control of power consumption, safe power-off operation, and resetting from a hang-up state by properly setting power supply to a plug-in module in accordance with the operational request and operational status of a digital broadcast receiving device and the plug-in module, a display device, a plug-in module, and a plug-in module power control method. Each of the digital broadcast receiving device and plug-in module includes an authentication part for equipment authentication thereof, CEC communication part for control signal communication, and a video audio transmitter receiver. The digital broadcast receiving device serves for switching the module power supply part for power supply to the plug-in module from standby power to main power in accordance with the control signal after equipment authentication is obtained for the plug-in module.

### TECHNICAL FIELD

The present invention relates to a video display system comprising an externally installed plug-in module having specified communication function and information processing function which is externally connected to a display device, a display device, a plug-in module, and a power control method of the plug-in module.

### BACKGROUND ART

Recently, digital broadcast receiving devices compatible with ground digital broadcast and BS digital broadcast are rapidly becoming higher in performance with enhancement of picture quality and enlargement of screen size. Internet connecting function, recording function interlocked with broadcast programs, and decoding function for charged broadcast reception can be mentioned as representative ones.

On the other hand, such additional functions are faster in technical innovation as compared with broadcast program audio-video function that is the essential function of a digital broadcast receiving device. Accordingly, there is a high possibility that the additional functions included in a digital broadcast receiving device which can be used for a relatively long period of time become out of date. Also, naturally, it is unable to cope with new functions put into practical use after purchase of the broadcast receiving device.

Further, most purchasers of digital broadcast receiving devices do not always desire such additional functions. Therefore, if it is provided with various functions, most of the functions will be unnecessary for the purchaser, and consequently, the purchaser has to buy a comparatively high-priced product.

In this respect, it is desirable to provide the purchaser who desires to have such functions with these additional functions by allowing them to additionally install such functions as external devices of the digital broadcast receiving device or to renew (newly purchase) the external devices. Also, such external devices are for example reduced in size so that they are mechanically detachable on the rear or side surface of the broadcast receiving device, and further, it is devised so that power can be supplied from the digital broadcast receiving device. In this way, no additional connection wiring or power wiring is needed, and it is remarkably effective for maintenance of the beauty and using convenience for the user.

Thus, an external plug-in module which can be mechanically installed in the main body of a digital broadcast receiving device and is also capable of receiving power from the broadcast receiving device is now under development. An external module having an Internet connecting function and animation reproducing function using it or a module having a long-time recoding function by a hard disk is already available as a commercialized example of module.

For effective operation of the plug-in module, power control is an important problem. That is, since power of the plug-in module is supplied from the digital broadcast receiving device, the power consumed becomes increased when power is continuously supplied. Particularly, increase in power consumption is remarkable in case it is capable of installing a plurality of plug-in modules.

Simultaneously, authentication of the plug-in module is also an important problem. Since the plug-in module is detachable, there is a possibility that it is detached and illegally used. For example, there is a possibility that the inside structure is stolen and changed into a so-called pirated plug-in module or the plug-in module is illegally used free of charge when it has a function of receiving charged services. Also, in case personal information of the user is stored in the plug-in module, there is a fear of leaking of the personal information.

With respect to such problems, there is a proposal such that authentication is executed between the apparatuses before operation of main functions, and power supply from the apparatus of the power feeding side to the apparatus of the power receiving side is controlled in accordance with the result. Such a proposal is disclosed, for example, in Patent document 1 and Patent document 2.

In Patent document 1, it is described that when audio data is transmitted from a personal computer to a portable audio player via USB cable, authentication is executed between the apparatuses before controlling the power supply. There is an advantage that power is not consumed unnecessarily for portable audio players not subjected to the authentication because power supply is discontinued thereafter.

In Patent document 2, it is described that when a personal computer is connected to IC card, power is first supplied from the personal computer to the IC card by using induction electromotive force used in IC tag communication, then the authentication function is operated by using the power, and when the authentication is normal, power is supplied from the personal computer to the IC card via an ordinary electric contact. In this proposal, besides the authentication operation, the self-diagnosis function of IC card can also be activated before main power supply. Accordingly, it is possible to prevent the connected interface at the personal computer side from being damaged due to excessive current flowing in main power connection because of defective circuits in the IC card. Since it is just enough to supply a small amount of power to the IC card, it is possible to realize non-contact power supply with induction electromotive force.

Also, as to connection between a digital broadcast receiving device and other externally connected video acoustic devices, there exists a standard for HDMI (High-Definition Multimedia Interface). Using a system conforming to this standard, video/audio data transmission between apparatuses, and remote or interlock control and authentication between apparatuses can be executed by using specified cables. Accordingly, such a system can be employed for the connection between a digital broadcast receiving device and a plug-in module.

In each of the above-mentioned Patent document 1 and Patent document 2, it is disclosed that authentication is first executed between the main body of information processing function device (personal computer in these patent documents) and the apparatus connected thereto (portable audio player in Patent document 1, IC card in Patent document 2), and power supply to the connected apparatus is controlled on the basis of the result.

However, in Patent document 1, when a proper portable audio player is connected, no particular power supply control is executed, and in addition, a proper portable audio player is connected in most cases, and therefore, it is just mainly intended to enhance the reliability of apparatus authenticating operation rather than obtaining the effect of power control.

Also, in Patent document 2, by supplying slight power at the initial authentication stage, it is possible to realize saving power consumption within the time and preventing excessive current flowing due to defective IC card, but also in this case, power is controlled only for a short time in card setting, and as the period of continuous power supply thereafter is very long, there is almost no effect with respect to power consumption. Also, for sending and receiving induction electromotive force, it is required to install relevant circuits in each apparatus, resulting in increase of the cost.

HDMI has excellent function for video/audio data transmission and apparatus control, but since each apparatus is originally supposed to have an individual power source, it is not provided with a system for power saving in operational mode although there is provided power ON/OFF control for other apparatuses. Also, copyright management is executed for contents transmitted, but apparatus authentication is not executed.

Patent document 1 Unexamined Japanese Patent Publication 2001-243707
Patent document 2 Unexamined Japanese Patent Publication 2006-293943

### SUMMARY OF THE INVENTION

The present invention is intended to solve the problems of the conventional system described above, wherein power supply to plug-in module is properly set in accordance with the operational request and state of a digital broadcast receiving device and plug-in module. In this way, the present invention provides a video display system capable of effective control of power consumption, safe power-off operation, and restoration from hang-up state, display device, plug-in module, and a power control method of the plug-in module.

The video display system is a video display system comprising a display device for displaying pictures, and a plug-in module for transmitting video data to the display device, which is detachable from the display device. The display device includes a first authentication part for equipment authentication of the plug-in module, a first communication part for sending and receiving control signal to and from the plug-in module, a video data receiver for receiving video data of the plug-in module, a module power supply part for switching the plug-in module power supply to two kinds of power, standby power and main power, and a first controller for controlling the module power supply part in accordance with the result of authentication executed by the first authentication part or the control signal. The plug-in module includes a second authentication part for equipment authentication with the display device, a second communication part for sending and receiving control signal to and from the display device, a video data transmitter for transmitting video data, and a second controller for controlling the video data transmitter in accordance with the result of authentication executed by the second authentication part or the control signal. The first controller executes switching control of the module power supply part from standby power to main power after obtaining equipment authentication at the first authentication part or in accordance with the control signal.

The video display system is a video display system comprising a display device for displaying pictures, and a plug-in module for transmitting video data to the display device, which is detachable from the display device. The display device includes a first communication part for sending and receiving control signal to and from the plug-in module, a video data receiver for receiving video data of the plug-in module, a module power supply part for switching the plug-in module power supply to two kinds of power, standby power and main power, and a first controller for controlling the module power supply part in accordance with the control signal of the first communication part. The plug-in module includes a second communication part for sending and receiving control signal to and from the display device, a video data transmitter for transmitting video data, and a second controller for controlling the video data transmitter in accordance with the control signal. The first controller controls the module power supply part in accordance with the control signal.

The display device is a display device with a detachable plug-in module which transmits video data used in a video display system, comprising an authentication part for executing equipment authentication of the plug-in module, a communication part for sending and receiving control signal to and from the plug-in module, a video data receiver for receiving video data of the plug-in module, a module power supply part for switching the plug-in module power supply to two kinds of power, standby power and main power, and a controller for controlling the module power supply part in accordance with the result of authentication executed at the authentication part or the control signal. The controller executes switching control of the module power supply part from standby power to main power after obtaining equipment authentication executed at the authentication part or in accordance with the control signal.

The plug-in module is a plug-in module for transmitting video data, which is detachably installed in a display device used in a video display system, comprising an authentication part for executing equipment authentication with the display device, a communication part for sending and receiving control signal to and from the display device, a video data transmitter for transmitting video data, and a controller for controlling the video data transmitter in accordance with the result of authentication executed at the authentication part or the control signal.

A plug-in module power control method for controlling power supply to the plug-in module from the display device, wherein a video display system includes a display device for displaying pictures, and a plug-in module, detachably attached to the display device, for transmitting video data to the display device, comprises a step of executing equipment authentication of the plug-in module with the display device, and a step of executing switching control of the plug-in module power supply from standby power to main power after obtaining equipment authentication.

A plug-in module power control method for controlling power supply to the plug-in module from the display device, wherein a video display system includes a display device for displaying pictures, and a plug-in module, detachably attached to the display device, for transmitting video data to the display device, comprises a step of executing equipment authentication of the plug-in module with the display device, a step of sending and receiving control signal between the plug-in module and the display device, and a step of executing switching control of power supply from standby power to main power after obtaining equipment authentication.

### BRIEF DESCRIPTION OF DRAWINGS

FIG. 1 is an appearance diagram showing the connected state of a digital broadcast receiving device and a plug-in module of the video display system of the present invention.

FIG. 2 is a block diagram of a digital broadcast receiving device and a plug-in module of the video display system in the first preferred embodiment of the present invention.

FIG. 3 is a block diagram of a digital broadcast receiving device and a plug-in module of the video display system in the second preferred embodiment of the present invention.

FIG. 4 is a process flow chart in authentication obtained between a digital broadcast receiving device and a plug-in module of the video display system in the second preferred embodiment of the present invention.

FIG. 5 is a process flow chart in authentication failure between a digital broadcast receiving device and a plug-in module of the video display system in the second preferred embodiment of the present invention.

FIG. 6 is a process flow chart for standby until plug-in module operation after obtaining authentication between a digital broadcast receiving device and a plug-in module of the video display system in the second preferred embodiment of the present invention.

FIG. 7 is a process flow chart for standby until power-on request from the plug-in module after obtaining authentication between a digital broadcast receiving device and a plug-in module of the video display system in the second preferred embodiment of the present invention.

FIG. 8 is a process flow chart at the time of power-off request from the digital broadcast receiving device to the plug-in module of the video display system in the second preferred embodiment of the present invention.

FIG. 9 is a process flow chart in advance monitoring at the time of power-off request from the digital broadcast receiving device to the plug-in module of the video display system in the second preferred embodiment of the present invention.

FIG. 10 is a process flow chart at the time of power-off request from the plug-in module to the digital broadcast receiving device of the video display system in the second preferred embodiment of the present invention.

FIG. 11 is a flow chart at the time of re-starting needed because of trouble in the plug-in module of the video display system of the second preferred embodiment of the present invention.

### DESCRIPTION OF REFERENCE MARKS

100, 100A, 100B Digital broadcast receiving device
101 Broadcast receiving device controller (first device controller)
102 Module power supply part
103 Authentication part (first authentication part)
203 Authentication part (second authentication part)
104 CEC communication part (first communication part)
204 CEC communication part (second communication part)
105, 205 Video audio transmitter receiver
110 Setting slot
200, 200A, 200B Plug-in module
201 Module controller (second device controller)
300A, 300B Module connecting cable
301 Main power supply wire
302 Standby power supply wire
303 Authentication secure communication wire
400 HDMI cable
401 CEC signal wire
402 Video audio data wire

### PREFERRED EMBODIMENTS FOR CARRYING OUT THE INVENTION

The preferred embodiments of the present invention will be described in the following with reference to the drawings.

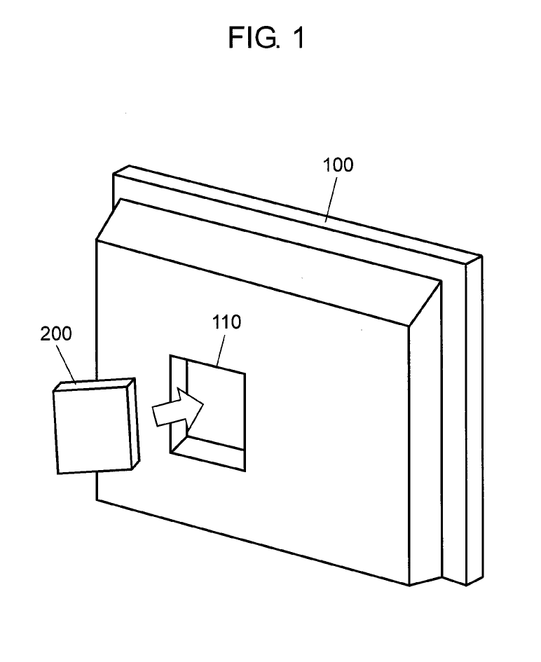

FIG. 1 is an appearance diagram showing the connected state of a digital broadcast receiving device and a plug-in module of the video display system of the present invention. Digital broadcast receiving device 100 is a display device for displaying pictures of television broadcast and the like, which is for example a liquid crystal television or a plasma television. In FIG. 1, the rear of digital broadcast receiving device 100 is shown. Digital broadcast receiving device 100 is provided with setting slot 110 at the rear thereof, and plug-in module 200 is set into setting slot 110. Setting slot 110 and plug-in module 200 are connected by module connecting cable and HDMI cable for receiving control signal and supplying power. Instead of connecting by using electric contact for receiving control signal, it is possible to make the connection by using optical fiber or contactless space connection by means of radio, electromagnetic induction, optical communication or the like.

### First Preferred Embodiment

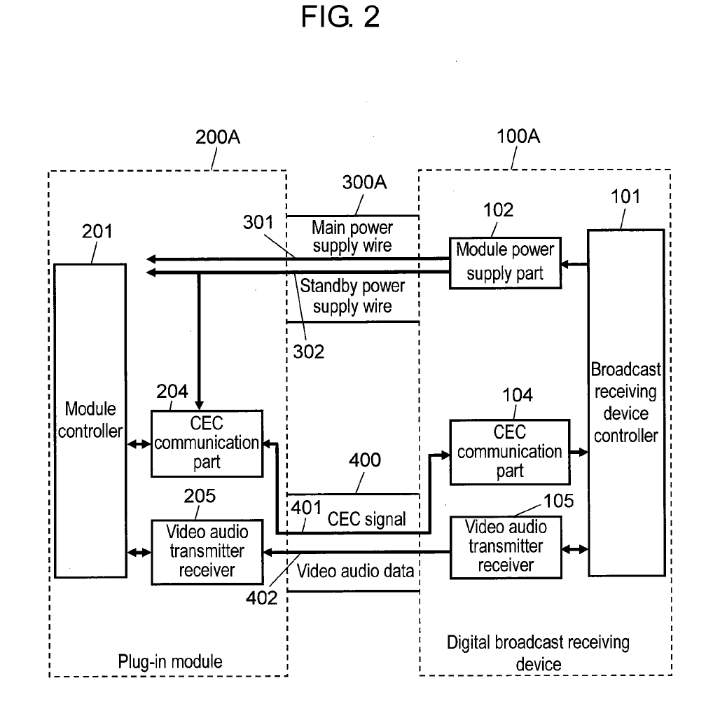

FIG. 2 is a block diagram of a digital broadcast receiving device and a plug-in module of the video display system in the first preferred embodiment of the present invention. In FIG. 2, digital broadcast receiving device 100A, plug-in module 200A, and module connecting cable 300A and HDMI cable 400 for connecting digital broadcast receiving device 100A to plug-in module 200A are shown, in which the configuration of a portion for each connecting function and the connecting wire between the both are shown. As to digital broadcast receiving device 100A, digital television broadcast that is a representative example is described in the following with respect to a television receiver for signal reception, demodulation, and display.

Video audio data transmission and reception between digital broadcast receiving device 100A and plug-in module 200A, and control between the both are executed via HDMI cable 400 that is a connecting cable. HDMI cable 400, television receivers, and video-related products which are compatible with HDMI cable 400 are already propagated. CEC signal wire 401 for control and video audio data wire 402 are included in HDMI cable 400.

Communication between broadcast receiving device controller (hereinafter abbreviated to “device controller”) 101 for controlling digital broadcast receiving device 100A and module controller 201 is realized by CEC communication part 104, CEC communication 204, and CEC signal wire 401. Device controller 101 is an example of first controller. Module controller 201 is an example of second controller for controlling plug-in module 200A. CEC communication part 104 is an example of first communication part, and CEC communication part 204 is an example of second communication part. CEC signal wire 401 connects CEC communication part 104 to CEC communication part 204.

Video audio data transmission and reception between digital broadcast receiving device 100A and plug-in module 200A is realized by video audio transmitter receiver 105 installed internally thereof, video audio transmitter receiver 205, and video audio data wire 402. Video audio transmitter receiver 105 is an example of video data receiver, and video audio transmitter receiver 205 is an example of video data transmitter. Video audio data wire 402 connects video audio transmitter receiver 105 to video audio transmitter receiver 205.

Here, in case plug-in module 200A is a digital broadcast receiving module, video data or the like is transmitted from plug-in module 200A to digital broadcast receiving device 100A. In case plug-in module 200A is, for example, a hard disc recording module or the like, video data or the like is transmitted from digital broadcast receiving device 100A to plug-in module 200A.

Next, device controller 101 in digital broadcast receiving device 100A controls module power supply part 102 to supply power to plug-in module 200A via main power supply wire 301 and standby power supply wire 302 in module connecting cable 300A. When power is supplied to digital broadcast receiving device 100A, device controller 101 turns ON the standby power of module power supply part 102. Power supply by standby power supply wire 302 is performed, as shown in FIG. 2, to CEC communication part 204 being concerned with processing, sending and receiving control signal. In this condition, it is possible to make control signal communication between CEC communication part 104 and CEC communication part 204.

After that, device controller 101 receives control signal from module controller 201 in plug-in module 200A via CEC communication part 104 and CEC communication part 204. Module power supply part 102 is switched from standby power to main power in accordance with the control signal. Generally, the power consumed in operation of plug-in module 200A with main power is around several tens watts, while the standby power consumed is less than a few watts. The reason for this is that, as described above, in power supply by standby power supply wire 302, the power is supplied only to the circuit of standby function including CEC communication part 204. On the other hand, in power supply by main power supply wire 301, the power is supplied to all parts including CEC communication part 204 as power for main functions such as video audio receiver 205.

Thus, when power is supplied to digital broadcast receiving device 100A, main power is not automatically supplied to plug-in module 200A but the main power is supplied only when needed, thereby enabling the reduction of power consumed. Here, the case of when needed is such that when an external signal for operation of plug-in module 200A is received or when it is necessary to supply main power judging from the state of plug-in module 200A itself. With power supplied by main power supply wire 301, CEC communication part 204 can also be operated with main power, and therefore, it is also possible to discontinue power supply from standby power supply wire 302. Generally, the standby power circuit is poor in power efficiency because the power generated is only a few watts, causing the loss to be increased. On the other hand, the main power circuit is excellent in power efficiency and little in loss, and power can be supplied from the main power source to the circuit of standby function as well, making it possible to further reduce the power consumption.

### Second Preferred Embodiment

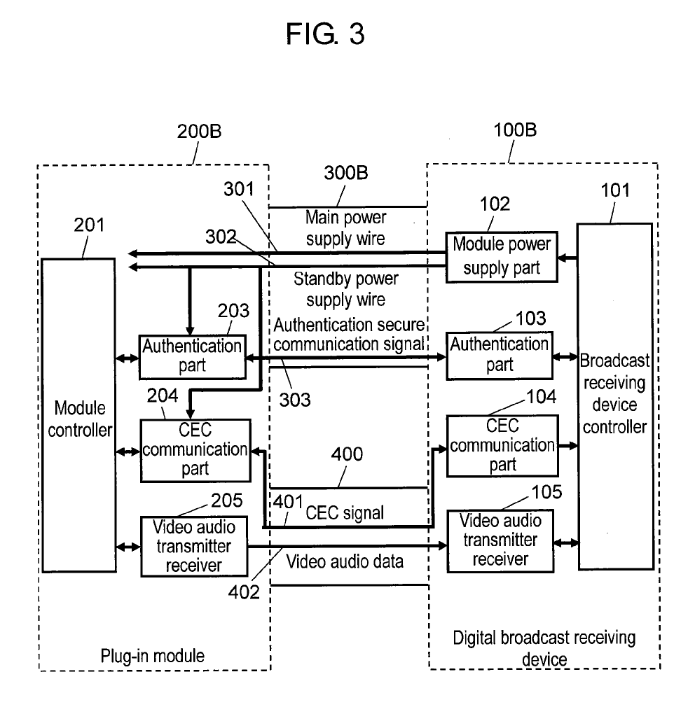

FIG. 3 is a block diagram of a digital broadcast receiving device and a plug-in module of the video display system in the second preferred embodiment of the present invention. Shown in FIG. 3 is a configuration formed by adding function block for authentication and signal line to the configuration shown in FIG. 2. For authentication of plug-in module 200B, authentication part 103 and authentication part 203 are respectively installed in digital broadcast receiving device 100B and plug-in module 200B, and equipment authentication is executed via authentication secure communication wire 303 which is encrypted and installed in module connecting cable 300B.

Authentication part 103 is an example of first authentication part for equipment authentication. Authentication part 203 is an example of second authentication part for equipment authentication. HDMI also includes authentication function, but it is HDCP (High-bandwidth Digital Content Protection system) authentication limited to the use for copy control. Accordingly, the purpose of HDMI is different from the equipment authentication of plug-in module 200B itself. Also, authentication part 203 is supplied with standby power the same as for CEC communication part 204.

Using the configuration of FIG. 3 as an example, how the power supply is controlled in some operations with digital broadcast receiving device 100B and plug-in module 200B will be described in the following, showing the flow of control signal between the both and the content of power control.

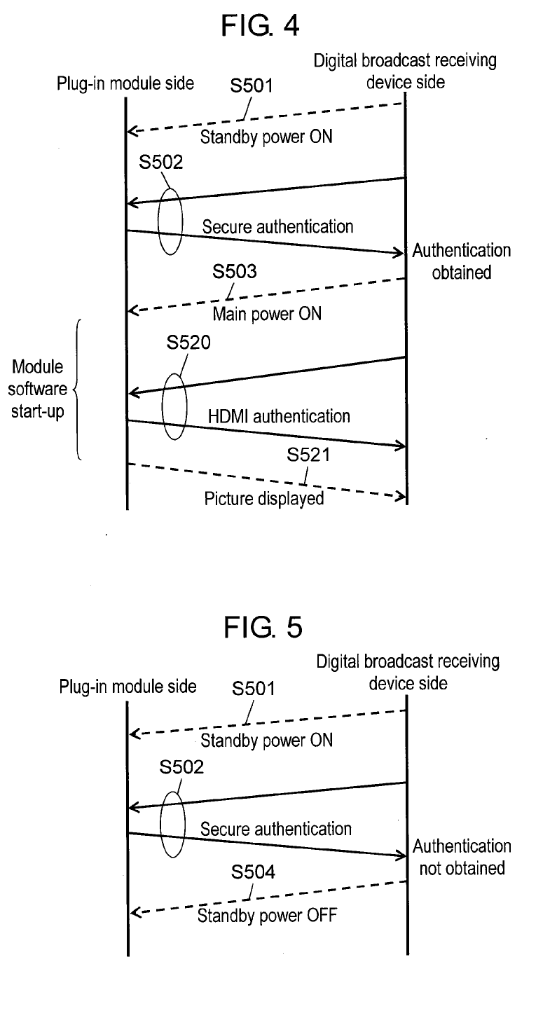

FIG. 4 is a process flow chart with authentication obtained between a digital broadcast receiving device and a plug-in module of the video display system in the second preferred embodiment of the present invention. FIG. 5 is a process flow chart in authentication failure between a digital broadcast receiving device and a plug-in module of the video display system in the second preferred embodiment of the present invention. Shown in FIG. 4 and FIG. 5 are the flow of authentication signal and the state of power supply control in authentication operation immediately after installation of plug-in module 200B in digital broadcast receiving device 100B or immediately after start of digital broadcast receiving device 100B in which plug-in module 200B is installed. The solid allow-mark line is the flow of control signal, and the dotted arrow-mark line shows actual control of power supply or the like.

In FIG. 4, when power is first supplied to digital broadcast receiving device 100B, device controller 101 controls module power supply part 102 to supply standby power to plug-in module 200B (step S501).

Subsequently, device controller 101 executes an inquiry for authentication to authentication part 203 via authentication part 103 (step S502). When the authentication is obtained with the reply of authentication received from authentication part 203, device controller 101 immediately serves to supply main power to plug-in module 200B from module power supply part 102 (step S503). With main power supplied, module controller 201 of plug-in module 200B and module software mounted in ROM or the like (not shown) are started.

After that, device controller 101 further executes HDMI authentication on the basis of HDCP or the like under the standard support of HDMI (step S520). With HDMI authentication obtained, then for the first time, device controller 101 instructs module controller 201 of plug-in module 200B to transmit video data to digital broadcast receiving device 100B. Receiving the instruction, module controller 201 sends video audio data from video audio transmitter receiver 205 to digital broadcast receiving device 100B via video audio data wire 402. And then, device controller 101 operates so that the video audio data received by video audio transmitter receiver 105 of broadcast receiving device 100B is displayed (picture-displayed) on the display screen (step S521). The detailed description with respect to the HDMI authentication is omitted.

As described above, then in the case of supplying main power, including the function block primarily supplied with standby power, it is not necessary to continue supplying standby power, and therefore, standby power-off processing is finally added. In FIG. 4 and the following figures, the standby power-off operation is not shown, but such a case is also included.

FIG. 5 shows a case such that authentication is not obtained in step S502. It is not necessary to continue standby power supply to plug-in module 200B not correctly authenticated. Accordingly, device controller 101 controls module power supply part 102 so that standby power is immediately turned OFF (step S504).

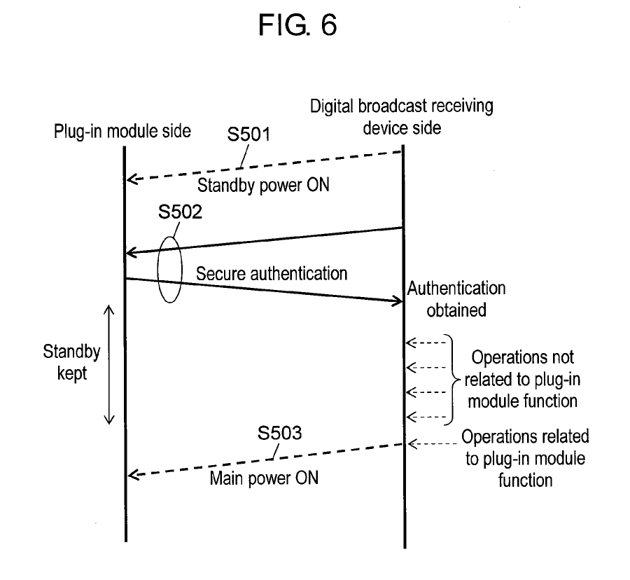

FIG. 6 is a process flow chart for standby until operation of the plug-in module after obtaining authentication between a digital broadcast receiving device and a plug-in module of the video display system in the second preferred embodiment of the present invention. That is, FIG. 6 shows such a case that even when authentication is obtained in step S502, device controller 101 does not serve to immediately turn ON the main power of module power supply part 102. Out of various operations executed on digital broadcast receiving device 100B, even when operations not related to the function of plug-in module 200B are executed repeatedly, device controller 101 will not react to the operations. And, only when an operation related to the function of plug-in module 200B is executed, device controller 101 will react to the operation and immediately turn ON the main power of module power supply part 102 (step S503).

The function of reacting to operations or selecting the one reflected in control for turning main power ON out of the operations is realized by device controller 101 in FIG. 3. As a result, it is possible to execute efficient power control for supplying main power to plug-in module 200B only when needed. The above-mentioned operations are not always executed by using the operation key on the main body of digital broadcast receiving device 100B. The operations include those executed by using the attached remote controller or those remotely executed from other devices connected in cable or wireless fashion.

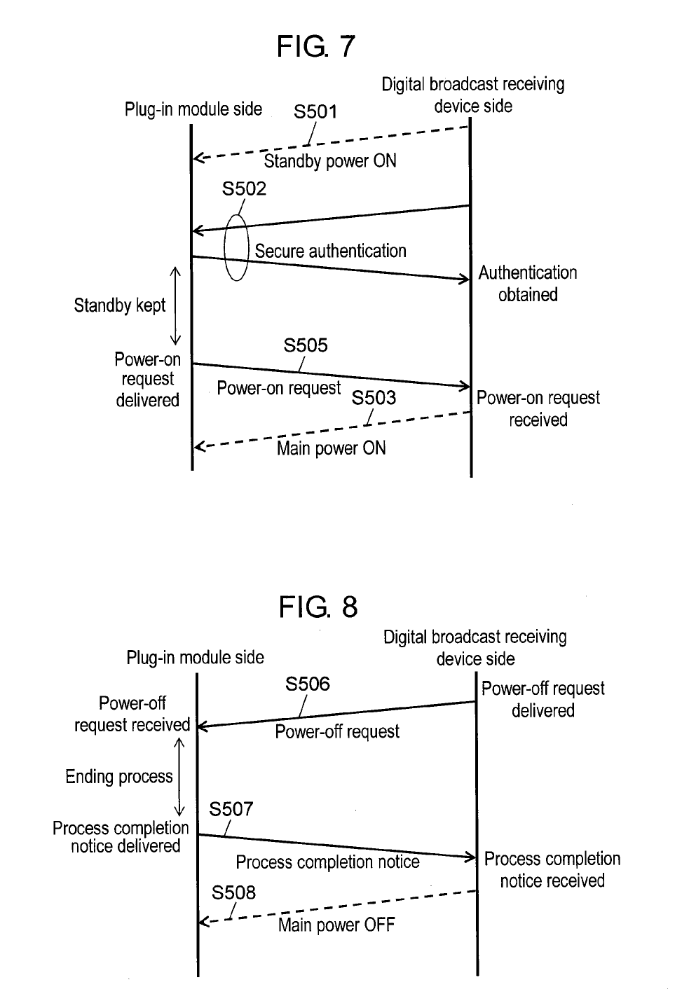

FIG. 7 is a process flow chart for standby until power-on request from plug-in module after obtaining authentication between a digital broadcast receiving device and a plug-in module of the video display system in the second preferred embodiment of the present invention. Same as in FIG. 6, FIG. 7 shows such a case that device controller 101 is in standby mode until becoming needed without immediately turning ON the main power of module power supply part 102 even when authentication is obtained in step S502. Module controller 201 of plug-in module 200B sends a power-on request by using CEC signal wire 401 to CEC communication part 104 of digital broadcast receiving device 100B via CEC communication part 204 (step S505). Device controller 101 of digital broadcast receiving device 100B receives the power-on request and controls module power supply part 102 to immediately turn ON the main power (step S503). Also in this case, efficient power control for supplying main power to plug-in module 200B can be executed only when needed.

As an example of making a power-on request from plug-in module 200B, in case plug-in module 200B is provided with a function of viewing reservation or recording reservation, it is sometimes necessary to send video audio data or to start up the recording part such as hard disc on the reserved time. Or, a case can be mentioned such that software (firmware) for operation of plug-in module 200B itself is downloaded from broadcast signal or network on the specified time and it is required to start up the receiving function on the specified time.

Further, when the attached remote controller is used for the operation, it can be considered that the receiving part (light receiving part in case of using infrared ray) for receiving the control signal from the remote controller is not mounted at the digital broadcast receiving device 100B side but it is mounted at the plug-in module 200B side. In that case, the control signal received by the receiving part of plug-in module 200B is received by module controller 201 and is transmitted to device controller 101 via CEC communication part 204 and CEC communication part 104. And, when it is judged that the operation is related to plug-in module 200B, then module controller 201 sends an instruction to device controller 101 so as to turn ON the main power of plug-in module 200B.

FIG. 8 is a process flow chart at the time of power-off request from the digital broadcast receiving device to a plug-in module of the video display system in the second preferred embodiment of the present invention. FIG. 8 shows the flow of control signal and the state of power control when digital broadcast receiving device 100B stops the main power supply to plug-in module 200B. Digital broadcast receiving device 100B does not directly stop the main power supply, but device controller 101 first sends a power-off request to CEC communication part 204 of plug-in module 200B via CEC communication part 104 (step S506). Plug-in module 200B starts an internal ending process after receiving the power-off request. As an ending process, a process for normal ending of the internal software, a process for ending writing in the memory, obtaining latest electronic programs, software downloading, or a process for mechanical protection in case of having a recording part such as a hard disc can be mentioned.

After the process of plug-in module 200B is reliably completed, module controller 201 transmits a notice of ending process completion from CEC communication part 204 to CEC communication part 104 of digital broadcast receiving device 100B (step S507). After receiving the notice of process completion, device controller 101 of digital broadcast receiving device 100B immediately stops the main power supply of module power supply part 102 (step S508).

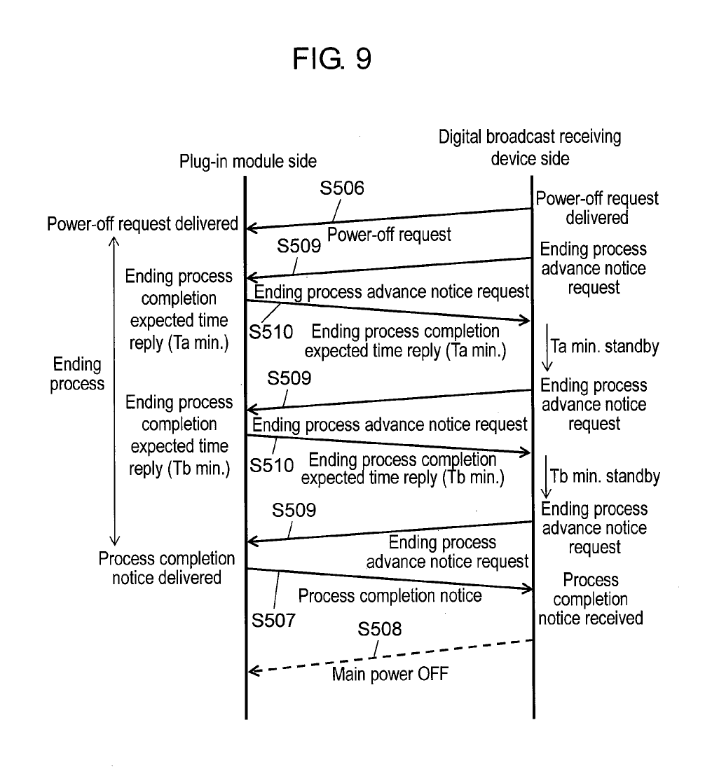

FIG. 9 is a process flow chart in advance monitoring at the time of power-off request from a digital broadcast receiving device to a plug-in module of the video display system in the second preferred embodiment of the present invention. Same as in FIG. 8, FIG. 9 shows the flow of control signal and the state of power control when digital broadcast receiving device 100B stops the main power supply to plug-in module 200B. The difference of the process flow shown in FIG. 9 from the process flow of FIG. 8 is that device controller 101 transmits an ending process advance request while waiting for the ending process completion notice from module controller 201. That is, digital broadcast receiving device 100B transmits a power-off request in step S506, and subsequently transmits an ending process advance notice request to plug-in module 200B (step S509).

Module controller 201 of plug-in module 200B makes a reply to the advance notice request by sending the expected time of ending process completion (step S510). For example, when the content of the reply is “Ta min. later,” then, device controller 101 of digital broadcast receiving device 100B again transmits Ta min. later an ending process advance notice request to module controller 201 of plug-in module 200B (step S509). In reply to this ending process advance notice request, when processing time is still needed at that point, module controller 201 of plug-in module 200B again sends the expected time of process ending completion in step S510. For example, when the content of the replay is “Tb min. later,” then device controller 101 of digital broadcast receiving device 100B again transmits Tb min. later an ending process advance notice request to module controller 201 of plug-in module 200B in step S510. When the process is completed at that point, module controller 201 of plug-in module 200B transmits an ending process completion notice in step S507 the same as in the case of FIG. 8. And then, after receiving the ending process completion notice, device controller 101 of digital broadcast receiving device 100B immediately operates to stop the main power supply of module power supply part 102 (step S508).

The advance checking operation is advantageous in that digital broadcast receiving device 100B can be prevented from being kept in standby mode endlessly due to trouble in plug-in module 200B. Also, since the operation advance status can be informed to the user by displaying the expected time of ending on the screen, it provides a good function so that the user will not have a long-awaiting feeling.

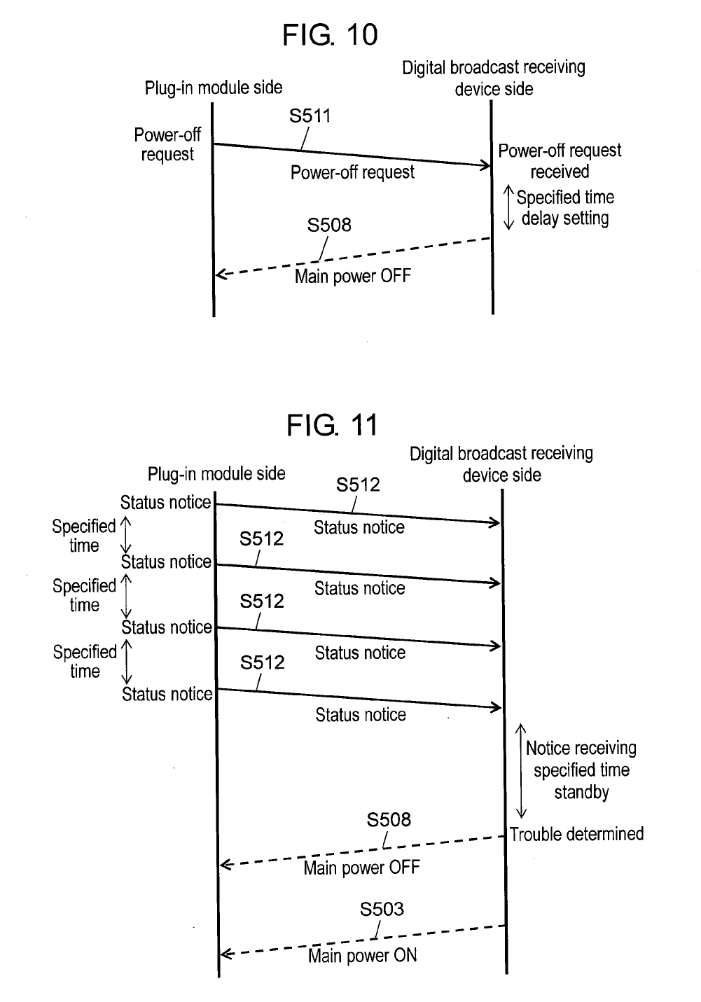

FIG. 10 is a process flow chart at the time of power-off request from a plug-in module to a digital broadcast receiving device of the video display system in the second preferred embodiment of the present invention. FIG. 10 shows the flow of control signal and the condition of power control when a power-off request is transmitted from plug-in module 200B. CEC communication part 104 receives the power-off request transmitted from module controller 201 of plug-in module 200B via CEC communication part 204 (step S511). And then, device controller 101 of digital broadcast receiving device 100B, after lapse of the previously set delay time, stops the main power supply of module power supply part 102 (step S508). Module controller 201 of plug-in module 200B is supposed to complete the necessary ending process before transmission of the power-off request. However, to provide some allowance, taking into account the diversity of specifications in various plug-in modules, it is appropriate to stop the main power supply after lapse of a specific delay time. If it is allowable to suppose only the ending process of software in plug-in module 200B, the above-mentioned delay time is just enough to be a few seconds.

As a specific example of sending a power-off request from plug-in module 200B, such a case can be mentioned that plug-in module 200B detects itself that it is in need of re-starting and required to once stop the main power supply. In some configuration of plug-in module 200B, it is sometimes necessary to stop the standby power supply.

FIG. 11 is a process flow chart at the time of re-starting needed because of trouble in a plug-in module of a video display system of the second preferred embodiment of the present invention. FIG. 11 shows the flow of control signal and the condition of power control in case of stopping the main power supply when digital broadcast receiving device 100B detects that plug-in module 200B is in trouble being in need of re-starting. Module controller 201 of plug-in module 200B repeats the delivery of a status notice that the module is in normal operation to CEC communication part 104 of digital broadcast receiving device 100B every interval of a predetermined time from CEC communication part 204 (step S512). Device controller 101 of digital broadcast receiving device 100B receives the status notice and detects the normal operation of plug-in module 200B. When the status notice is not received for more than the predetermined standby time, device controller 101 determines that plug-in module 200B is in a state of trouble such as so-called a hang-up state. And then, device controller 101 once stops the main power supply of module power supply part 102 for re-starting of plug-in module 200B (step S508). Device controller 101 again starts 2 to 5 seconds later the main power supply of module power supply part 102 (step S503). In this way, it becomes possible to automatically re-start the hung-up plug-in module 200B.

As described above, according to the present invention, in the video display system comprising plug-in modules 200, 200A, and 200B, having specified communication function and information processing function, which are externally connected to digital broadcast receiving devices 100, 100A, and 100B, standby power and main power supply switching operations can be effectively controlled. Accordingly, it is possible to efficiently save the power supplied to plug-in modules 200, 200A, and 200B. Also, when stopping power supply to plug-in modules 200, 200A, and 200B, the power supply is stopped according to the notice of ending process completion of plug-in modules 200, 200A, and 200B, and thereby, power supply can be safely stopped. Further, it is possible to detect the state of hang-up of plug-in modules 200, 200A, and 200B, and to stop main power supply and to resume the power supply for automatically re-starting the operation.

Also, in the case of the present invention, it is just enough to prepare a connection cable for power supply or a connection cable for receiving authentication signal for the HDMI connection function already widely employed, and as to the software added, it is just enough to provide such a simple processing procedure as described in the above preferred embodiments.

Further, since it can be predicted that various types of externally installed plug-in modules will be commercialized in future in order to realize digital broadcast receiving devices having multiple functions, the present invention becomes more and more useful.

In the above preferred embodiments, when the power of digital broadcast receiving device 100, 100A, and 100B is started, device controller 101 serves to turn ON the standby power of module power supply part 102, and after that, equipment authentication is executed as described. However, it is also allowable to be configured in that even with the power of digital broadcast receiving device 100, 100A, and 100B turned ON and with plug-in module 200, 200A, and 200B disconnected and connected, device controller 101 detects plug-in module 200, 200A, and 200B via CEC communication part 104, 204, and after that, equipment authentication is executed.

As is obvious in the above description, according to the present invention, the power supply to the plug-in module can be properly set in accordance with the request for operation or operational condition of the digital broadcast receiving device and plug-in module. Accordingly, it is possible to provide a video display system capable of efficient control of power consumption, safe power-on operation, and reset from hang-up state, a display device, a plug-in module, and a power supply control method for the plug-in module.

### INDUSTRIAL APPLICABILITY

In a video display system comprising an externally installed plug-in module having specified communication function and information processing function which is externally connected to a digital broadcast receiving device, the present invention is intended to effectively perform power control of the plug-in module and can be widely applied to a video display system mounted with a plug-in module.

1. A video display system comprising:
a display device for displaying pictures; and
a plug-in module which is detachably attached to the display device and transmits video data to the display device,
wherein the display device includes:
a first authentication part for executing equipment authentication of the plug-in module;
a first communication part for sending and receiving control signal to and from the plug-in module;
a video data receiver for receiving video data from the plug-in module;
a module power supply part for switching two types of powers, standby power and main power, of the plug-in module; and
a first controller for controlling the module power supply part in accordance with a result of authentication executed by the first authentication part or the control signal; and
the plug-in module includes:
a second authentication part for executing equipment authentication with the display device;
a second communication part for sending and receiving the control signal to and from the display device;
a video data transmitter for transmitting the video data; and
a second controller for controlling the video data transmitter in accordance with a result of authentication executed by the second authentication part or the control signal; and
the first controller controls the module power supply part for switching from standby power to main power after obtaining equipment authentication at the first authentication part or in accordance with the control signal.

2. The video display system of claim 1, wherein the first controller controls the module power supply part for switching from standby power to main power after obtaining equipment authentication at the first authentication part and further after acceptance of operation of the plug-in module.

3.-14. (canceled)

15. A display device with a detachable plug-in module which transmits video data used in the video display system; comprising:
an authentication part for executing equipment authentication of the plug-in module;
a communication part for sending and receiving control signal to and from the plug-in module;
a video data receiver for receiving video data of the plug-in module;
a module power supply part for switching two types of powers, standby power and main power, of the plug-in module; and
a controller for controlling the module power supply part in accordance with a result of authentication executed by the authentication part or the control signal,
wherein the controller controls the module power supply part for switching from standby power to main power after obtaining equipment authentication at the authentication part or in accordance with the control signal.

16. The display device of claim 15, wherein the controller controls the module power supply part for switching from standby power to main power after obtaining equipment authentication at the authentication part and further after accepting operation of the plug-in module.

17. The display device of claim 15, wherein the controller controls the module power supply part for switching from standby power to main power after equipment authentication is obtained at the authentication part and further after the communication part receives a power-on request from the plug-in module.

18. The display device of claim 15, wherein the controller controls for receiving the video data at the video data receiver after equipment authentication is obtained at the authentication part and further when HDCP authentication is obtained between the communication part and the plug-in module.

19. The display device of claim 15, wherein the controller controls for switching standby power of the module power supply part to OFF when equipment authentication is not obtained at the authentication part.

20. The display device of claim 15, wherein the controller controls for sending a power-off request from the communication part to the plug-in module, and controls for switching main power of the module power supply part to OFF after the communication part receives an ending process completion notice of the plug-in module that is transmitted from the plug-in module.

21. The display device of claim 15, wherein the controller controls for further sending an ending process advance notice request after sending a power-off request from the communication part to the plug-in module, and controls for standby for the ending process completion expected time when the communication part receives the ending process completion expected time of the plug-in module that is transmitted from the plug-in module.

22. The display device of claim 15, wherein the controller controls for switching main power of the module power supply part to OFF after delaying for a predetermined time when the communication part receives a power-off request from the plug-in module.

23. The display device of claim 15, wherein the controller controls for switching main power of the module power supply part once to OFF and again to ON thereafter when the communication part is unable to receive a status notice of the plug-in module from the plug-in module for more than a predetermined time and it is judged that the plug-in module is in a state of trouble.

24.-25. (canceled)

26. A plug-in module power control method for controlling power supply to the plug-in module from the display device,
wherein a video display system includes a display device for displaying pictures, and a plug-in module, detachably attached to the display device, for transmitting video data to the display device,
the method comprising:
a step of executing equipment authentication of the plug-in module with the display device; and
a step of control for switching the power supply of the plug-in module from standby power to main power after the equipment authentication is obtained.

27. The plug-in module power control method of claim 26, wherein the control step serves to control for switching power supply to the plug-in module from standby power to main power after obtaining the equipment authentication and further after accepting operation of the plug-in module.

28. The plug-in module power control method of claim 26, wherein the control step includes a step of receiving a power-on request from the plug-in module after obtaining the equipment authentication, and serves to control for switching the power supplied to the plug-in module from standby power to main power.

29. The plug-in module power control method of claim 26, wherein the control method further includes a step of HDCP authentication executed by the display device and the plug-in module after obtaining the equipment authentication, and serves to control for receiving the video data from the plug-in module when the HDCP authentication is obtained.

30. The plug-in module power control method of claim 26, wherein the control method serves to control for switching standby power supplied to the plug-in module to OFF when the equipment authentication is not obtained.

31. The plug-in module power control method of claim 26, wherein the control step includes:
a step of sending a power-off request to the plug-in module and a step of receiving an ending process completion notice of the plug-in module, and
serves to control for switching main power to OFF after receiving the process completion notice.

32. The plug-in module power control method of claim 26, wherein the control step includes:
a step of sending a power-off request to the plug-in module, and further, a step of sending an ending process advance notice request after sending the power-off request;
a step of receiving an ending process completion expected time of the plug-in module, and
serves to control for standby for the received ending process completion expected time.

33. The plug-in module power control method of claim 26, wherein the control step includes:
a step of receiving a power-off request from the plug-in module, and
serves to control for switching main power to OFF after delaying for a predetermined time when the power-off request is received.

34. The plug-in module power control method of claim 26, wherein the control step includes:
a step of receiving a status notice of the plug-in module, and
serves to control for switching main power once to OFF and again to ON thereafter when the status notice is not received for more than a predetermined time and it is judged that the plug-in module is in a state of trouble.
